(19) United States
(12) Patent Application Publication
(10) Pub. No.: US 2006/0025490 A1
(43) Pub. Date: Feb. 2, 2006

(54) Nonflammable foam body and method of manufacturing the foam body

(75) Inventors: Hiromu Saito, Koganei-shi (JP); Takafumi Oda, Koganei-shi (JP); Hiroshi Kawato, Ichihara-shi (JP); Toshitaka Kanai, Ichihara-shi (JP); Nobuhiro Watanabe, Ichihara-shi (JP); Takehito Konakazawa, Ichihara-shi (JP)

Correspondence Address: RANKIN, HILL, PORTER & CLARK LLP, 4080 ERIE STREET, WILLOUGHBY, OH, 44094-7836, US

(73) Assignee: Idemitsu Kosan Co., Ltd., Tokyo (JP)

(21) Appl. No.: 11/238,274

(22) Filed: Sep. 29, 2005

Related U.S. Application Data
(63) Continuation of application No. 10/482,495, filed on Jan. 23, 2004.

(30) Foreign Application Priority Data
Jul. 5, 2001 (JP) 2001-205259

(51) Int. Cl. C08J 9/00

(52) U.S. Cl. 521/99; 521/154; 264/50

(57) ABSTRACT

A resin composition containing thermoplastic resin and a flame retardant is sufficiently kneaded and molded, and carbon dioxide in a supercritical state is caused to permeate into the resin composition. Subsequently, the resin composition is degassed by cooling and/or pressure reduction. As a result of degassing, a resin foam body having a fine and uniform micro-cellular foam structure is obtained. The resin foam body has a cyclic structure in which a resin phase and a pore phase are continuous and intertwined. The obtained resin foam body can suitably find applications such as home OA parts, electric and electronic parts and automobile parts that are required to be highly strong, lightweight and nonflammable.

### TECHNICAL FIELD

The present invention relates to a nonflammable foam body that is produced by causing a nonflammable resin composition to foam finely and a method of manufacturing such a foam body. More particularly, the present invention relates to a nonflammable foam body having micro-cells having a foam cell diameter not greater than 10 μm or a cycle length not smaller than 5 nm and not greater than 100 μm. It also relates to a method of manufacturing such a foam body.

### BACKGROUND ART

There is a strong demand for lightweight and nonflammable materials that have state of the art or even improved physical properties including strength, rigidity and impact-resistance and are adapted to be used for OA apparatus, electric and electronic apparatus and parts, automobile parts and the like. Micro-cell foaming methods using gas in a supercritical state have been proposed to meet the demand. However, foam bodies that have a micro-cell structure and are made nonflammable to a reliable level for practical use have not been obtained to date.

### DISCLOSURE OF THE INVENTION

As a result of intensive research efforts, it is an object of the present invention to provide a nonflammable foam body having a micro-cell structure that is sufficiently nonflammable when used in practical applications such as OA apparatus, electric and electronic parts and automobile parts and has a fine and uniform foam structure.

A nonflammable foam body according to an aspect of the present invention is obtained by causing gas in a supercritical state to permeate into a resin composition containing thermoplastic resin and a flame retardant and subsequently degassing the resin composition.

Thus, according to the present invention, a nonflammable foam body is obtained by causing gas in a supercritical state to permeate into a resin composition containing thermoplastic resin and a flame retardant and subsequently degassing the resin composition. As a result, nonflammablity is realized and fine and uniform micro-cells are produced.

In the present invention, thermoplastic resin can be selected appropriately depending on the application and an alloy of a plurality of thermoplastic resins may be used. Examples of thermoplastic resin that is used for the present invention include polycarbonates, polyamides, polystyrenes, polypropylenes, polyethylenes, polyethers, ABSs, polyethylene terephthalate, polybutylene terephthalate, polymethyl methacrylate (PMMA), syndiotactic polystyrene, polyphenylene sulfide, polyallylates, polyimides such as polyether imide, polyether sulfone, polyether nitryl and various thermoplastic elastomers.

Of these resins, the use of polycarbonates (PC) that are currently being popularly used for OA apparatus and electronic, electric apparatus and automobile parts is particularly preferable to realize the advantages of the present invention. Incidentally, polycarbonate may be used alone or in combination with other thermoplastic resins, for example, any of the above listed resins.

Furthermore, a polycarbonate having branches (branched PC) or a polycarbonate-polyorganosiloxane copolymer having a polyorganosiloxane part or a mixture thereof are preferably used to produce a nonflammable foam body containing fine and uniform micro-cells. Known polycarbonates can be used for the purpose of the present invention. Examples of such polycarbonates include ordinary PCs, branched PCs and PC-polyorganosiloxane copolymers disclosed in Japanese Patent Laid-Open Publication No. Hei 7-258532.

A branched polycarbonate expressed by general formula (I) below is used as branching agent.

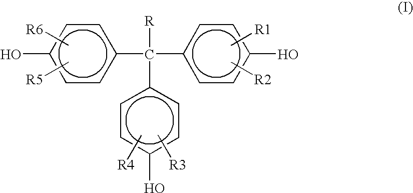

A branched polycarbonate having a branched core structure derived from a compound expressed by the general formula (I) is used. In the general formula (I), R represents a hydrogen atom or an alkyl group having 1 to 5 carbon atoms such as a methyl group, an ethyl group, an n-propyl group, an n-butyl group or an n-pentyl group and each of R1 through R6, which may be same or different from each other, represents a hydrogen atom, a halogen atom (e.g., chlorine, bromine, fluorine or iodine) or an alkyl group having 1 to 5 carbon atoms (e.g., a methyl group, an ethyl group, an n-propyl group, an n-butyl group or an n-pentyl group). R is preferably a methyl group and each of R1 through R6 is preferably a hydrogen atom.

Specific examples of compounds that are expressed by the general formula (I) include 1,1,1-tris(4-hydroxyphenyl)-methane, 1,1,1-tris(4-hydroxyphenyl)-ethane, 1,1,1-tris(4-hydroxyphenyl)-propane, 1,1,1-tris(2-methyl-4-hydroxyphenyl)-methane, 1,1,1-tris(2-methyl-4-hydroxyphenyl)-ethane, 1,1,1-tris(3-methyl-4-hydroxyphenyl)-methane, 1,1,1-tris(3-methyl-4-hydroxyphenyl)-ethane, 1,1,1-tris(3,5-dimethyl-4-hydroxyphenyl)-methane, 1,1,1-tris(3,5-dimethyl-4-hydroxyphenyl)-ethane, 1,1,1-tris(3-chloro-4-hydroxyphenyl)-methane, 1,1,1-tris(3-chloro-4-hydroxyphenyl)-ethane, 1,1,1-tris(3,5-dichloro-4-hydroxyphenyl)-methane, 1,1,1-tris(3,5-dichloro-4-hydroxyphenyl)-ethane, 1,1,1-tris(3-bromo-4-hydroxyphenyl)-methane, 1,1,1-tris(3-bromo-4-hydroxyphenyl)-ethane, 1,1,1-tris(3,5-dibromo-4-hydroxyphenyl)-methane and 1,1,1-tris(3,5-dibromo-4-hydroxyphenyl)-ethane. Of these compounds, 1,1,1-tris(4-hydroxyphenyl)-alkanes are preferable. Particularly, it is preferable to use 1,1,1-tris(4-hydroxyphenyl)-ethane, where R is a methyl group and each of R1 through R6 is a hydrogen atom.

Branched polycarbonates expressed by general formula (II) below can be used for the purpose of the invention.

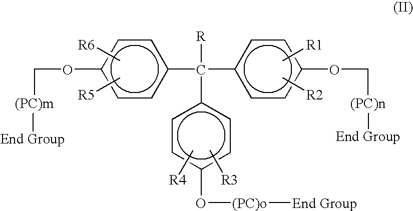

In the general formula (II), each of m, n and o represents an integer and PC represents a polycarbonate. When bisphenol A is used as component of the PC in the branched polycarbonate shown above, unit shown below in formula will be repeatedly used.

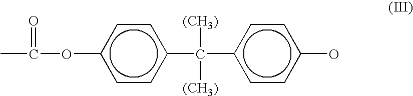

Branched polycarbonates preferably have a viscosity-average molecular weight not smaller than 15,000 and not greater than 40,000. The impact-resistance may be improperly reduced when the viscosity-average molecular weight is smaller than 15,000, whereas the moldability can be undesirably lowered when the viscosity-average molecular weight exceeds 40,000.

Preferably, branched polycarbonates contain an acetone-soluble portion by not greater than 3.5 mass %. Here, the acetone-soluble portion of the branched polycarbonate is made not greater than 3.5 mass % because the impact-resistance can be degraded when the acetone-soluble portion exceeds 3.5 mass %. An acetone-soluble portion as used herein refers to the content that is extracted from a branched polycarbonate by Soxhlet extraction using acetone as solvent.

A number of different methods can be used to manufacture a branched polycarbonate. For example, a method disclosed in Japanese Patent Laid-Open Publication No. Hei3-182524 can be used. More specifically, a reaction mixture containing an aromatic divalent phenol, a polycarbonate oligomer derived from a branching agent expressed by the general formula (I) and phosgene, an aromatic divalent phenol and a terminating agent reacts, while stirring the reaction mixture so as to produce a turbulence of the mixture. When the viscosity of the reaction mixture rises, an alkali solution is added to cause the reaction mixture to react as a laminar flow. A branched polycarbonate can be manufactured efficiently by this method.

As polycarbonates other than branched polycarbonates, or non-branched polycarbonates, aromatic polycarbonates expressed by general formula (IV) below are advantageously used.

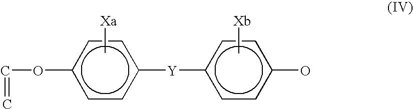

In the above formula (IV), X represents a hydrogen atom, a halogen atom (e.g., chlorine, bromine, fluorine or iodine) or an alkyl group having 1 to 8 carbon atoms (e.g., a methyl group, an ethyl group, a propyl group, an n-butyl group, an isobutyl group, an amyl group, an isoamyl group or a hexyl group). When there are two or more than two Xs, they may be the same and identical or different from each other. In the above formula (IV), a and b represent respective integers between 1 and 4 and Y represents a single bond, an alkylene group having 1 to 8 carbon atoms or an alkylidene group having 2 to 8 carbon atoms (e.g., methylene group, ethylene group, propylene group, butylene group, penterylene group, hexylene group, ethylidene group or isopropylidene group), a cycloalkylene group having 5 to 15 carbon atoms or a cycloalkylidene group having 5 to 15 carbon atoms (e.g., cyclopentylene group, cyclohexylene group, cyclopentylidene group or cyclohexylidene group), or a polymer having a structural unit expressed by a bond such as —S—, —SO—, —SO2—, —O—, —CO— or one expressed by formula (V) below.

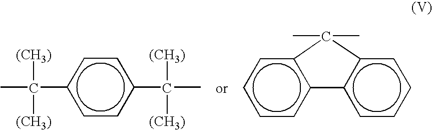

In the above formula (V), it is preferable that X represents a hydrogen atom and Y represents an ethylene or propylene group.

Such an aromatic polycarbonate can be easily manufactured by causing a divalent phenol and phosgene or a diester carbonate compound to react with each other.

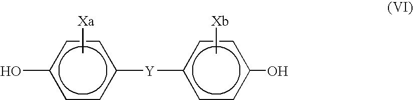

In the above formula (VI), X, Y, a and b are same as those described earlier. Thus, for example, a divalent phenol and a carbonate precursor such as phosgene are made to react each other or a divalent phenol and a carbonate precursor such as diphenyl carbonate are brought into an ester exchange reaction in a solvent such as methylene chloride in the presence of a known acid acceptor or a known molecular weight regulator to prepare such an aromatic polycarbonate.

Various compounds are known as divalent phenols expressed by the general formula (VI). Examples of such compounds include dihydroxy diarylalkanes such as bis(4-hydroxyphenyl)methane, bis(4-hydroxyphenyl)phenylmethane, bis(4-hydroxyphenyl)naphthylmethane, bis(4-hydroxyphenyl)-(4-isopropylphenyl)methane, bis(3,5-dichloro-4-hydroxyphenyl)methane, bis(3,5-dimethyl-4-hydroxyphenyl)methane, 1,1-bis(4-hydroxyphenyl)ethane, 1-naphtyl-1,1-bis(4-hydroxyphenyl)ethane, 1-phenyl-1,1-bis(4-hydroxylphenyl)ethane, 1,2-bis(4-hydroxyphenyl)ethane, 2,2-bis(4-hydroxyphenyl)propane [popularly known as: bisphenol A], 2-methyl-1,1-bis(4-hydroxyphenyl)propane, 2,2-bis(3,5-dimethyl-4-hydroxyphenyl)propane, 1-ethyl-1,1-bis(4-hydroxyphenyl)propane, 2,2-bis(3,5-dichloro-4-hydroxyphenyl)propane, 2,2-bis(3,5-dibromo-4-hydroxyphenyl)propane, 2,2-bis(3-chloro-4-hydroxyphenyl)propane, 2,2-bis(3-methyl-4-hydroxyphenyl)propane, 2,2-bis(3-fluoro-4-hydroxyphenyl)propane, 1,1-bis(4-hydroxyphenyl)butane, 2,2-bis(4-hydroxyphenyl)butane, 1,4-bis(4-hydroxyphenyl)butane, 2,2-bis(4-hydroxyphenyl)pentane, 4-methyl-2,2-bis(4-hydroxyphenyl)pentane, 2,2-bis(4-hydroxyphenyl)hexane, 4,4-bis(4-hydroxyphenyl)heptane, 2,2-bis(4-hydroxyphenyl)nonane, 1,10-bis(4-hydroxyphenyl)decane, 1,1-bis(4-hydroxyphenyl)-3,3,5-trimethylcyclohexane and 2,2-bis(4-hydroxyphenyl)-1,1,1,3,3,3-hexafluoropropane, dihydroxy diarylcycloalkanes such as 1,1-bis(4-hydroxyphenyl)cyclohexane, 1,1-bis(3,5-dichloro-4-hydroxyphenyl)cyclohexane and 1,1-bis(4-hydroxyphenyl)cyclodecane, dihydroxy diarylsulfones such as bis(4-hydroxyphenyl)sulfone, bis(3,5-dimechyl-4-hydroxyphenyl)sulfone and bis(3-chloro-4-hydroxyphenyl)sulfone, dihydroxy arylethers such as bis(4-hydroxyphenyl)ether and bis(3,5-dimechyl-4-hydroxyphenyl)ether, dihydroxy diarylketones such as 4,4′-dihydroxybenzophenone and 3,3′,5,5′-tetramethyl-4,4′-dihydroxybenzophenone, dihydroxy diarylsulfides such as bis(4-hydroxyphenyl)sulfide, bis(3-methyl-4-hydroxyphenyl)sulfide and bis(3,5-dimethyl-4-hydroxyphenyl)sulfide, dihydroxy diarylsulfoxides such as bis(4-hydroxyphenyl)sulfoxide, dihydroxy diphenyls such as 4,4′-dihydroxydiphenyl and dihydroxy arylfluorenes such as 9,9-bis(4-hydroxyphenyl)fluorene, of which 2,2-bis(4-hydroxyphenyl)propane [popularly known as: bisphenol A] is suitably used for the purpose of the present invention.

Examples of divalent phenols other than those expressed by the general formula (VI) include dihydroxy benzenes such as hydroquinone, resorcinol and methylhydroquinone and dihydroxy naphthalenes such as 1,5-dihydroxynaphthalene and 2,6-dihydroxynaphthalene. Any divalent phenol compounds of the above listed types may be used alone or in combination of two or more than two. Examples of diester carbonate compounds include diaryl carbonates such as diphenyl carbonate and dialkyl carbonates such as dimethyl carbonate and diethyl carbonate.

Various molecular weight regulating agents such as those that are normally used for polymerization of polycarbonates can be used. Specific examples include monovalent phenols such as phenol, p-cresol, p-tret-butylphenol, p-tret-octylphenol, p-cumylphenol, bromophenol, tribromophenol and nonyl phenol. An aromatic polycarbonate used for the present invention may be a mixture of two or more than two aromatic polycarbonates. In view of mechanical strength and the moldability, the viscosity average molecular weight of an aromatic polycarbonate is preferably not smaller than 10,000 and not greater than 100,000, more preferably between 20,000 and 40,000. In certain occasions, an aromatic polycarbonate may be a polycarbonate-polyorganosiloxane copolymer consisting of a polycarbonate part having a unit of repetition of a structure as expressed by general formula (VII) shown below and a polyorgan osiloxane part having a unit of repetition of a stricture as expressed by general formula (VIII) also shown below.

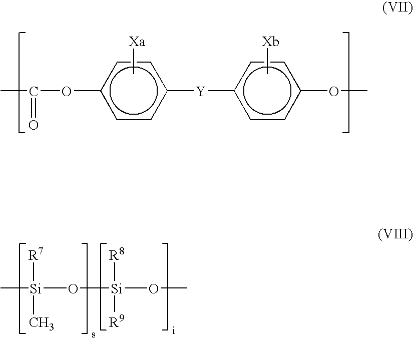

In the above formula (VII), X, Y, a and b are same as those described earlier. In the formula (VIII), each of R7, R8 and R9, which may be same or different from each other, represents a hydrogen atom, an alkyl group having 1 to 6 carbon atoms (e.g., a methyl group, an ethyl group, a propyl group, an n-butyl group, an isobutyl group, an amyl group, an isoamyl group or a hexyl group) or a phenyl group. In the formula (VII), each of s and i represents an integer that is 0 or greater than 1. The degree of polymerization of the polyorganosiloxane part as expressed by the general formula (VIII) is preferably not smaller than 5.

If the total mass of the polycarbonate-polyorganosiloxane copolymer is 100%, preferably the n-hexane-soluble part takes not greater than 1.0 mass % and shows a viscosity average molecular weight not smaller than 10,000 and not greater than 50,000 and the polydimethylsiloxane block takes not smaller than 0.5 mass % and not greater than 10 mass %.

When the viscosity average molecular weight of the polycarbonate-polyorganosiloxane copolymer is smaller than 10,000, its heat-resistance and strength are easily reduced and coarse foam cells can be produced. When, on the other hand, the viscosity average molecular weight of the polycarbonate-polyorganosiloxane copolymer exceeds 50,000, it can be difficult to produce foam. Thus, the viscosity average molecular weight of the polycarbonate-polyorganosiloxane copolymer is preferably not smaller than 10,000 and not greater than 50,000.

When the n-hexane-soluble part takes more than 1.0 mass %, the impact-resistance can be reduced. Thus, if the total mass of the copolymer is 100%, preferably the n-hexane-soluble part takes not greater than 1.0 mass %. The n-hexane-soluble part refers to the part of the copolymer in question that is soluble to and extracted by n-hexane when the n-hexane is used as solvent.

In the present invention, any flame retardant may be appropriately selected if it is suited for the application of the product. Flame retardants that can be used for the present invention include both halogen-based flame retardants and non-halogen-based flame retardants, although the use of a non-halogen-based flame retardant is preferable when environmently problems are taken into consideration.

Examples of halogen-based flame retardants include chlorine-based flame retardants such as chlorinated polyethylene, perchlorocyclopentadecane, chlorendic acid and tetrachlorophthalic anhydride and bromine-based flame retardants such as tetrabromobisphenol A, decabromodiphenylether, tetrabromodiphenylether, hexabromobenzene and hexabromodecane.

Examples of non-halogen-based flame retardants include phosphate ester flame retardants such as tricresyl phosphate, triphenyl phosphate and cresylphenyl phosphate, condensed type polyphosphates, organosiloxane-based phosphates, ammonium polyphosphates, nitrogen-containing phosphorus compounds, red phosphorus, polymeric phosphorous compound monomer vinyl phosphonates, organosulfonic acid of alkali metals and alkaline-earth metals and metallic salts such as magnesium hydroxide and aluminum hydroxide.

Preferable flame retardants for the present invention include non-halogen-containing phosphate ester flame retardants, metallic salts of non-halogen-based flame retardants and organosiloxane-based flame retardants. Not only highly nonflammable but also fine and uniform micro-cells are easily obtained when such a flame retardant is used. Examples of non-halogen-containing phosphate ester flame retardants include, for example, non-halogen-containing phosphate ester monomers as disclosed in Japanese Patent Laid-Open Publication No. Hei8-239654. Specific examples include trimethyl phosphate, triethyl phosphate, tributyl phosphate, trioctyl phosphate, tributoxyethyl phosphate, triphenyl phosphate, tricresyl phosphate, cresyldiphenyl phosphate and octyldiphenyl phosphate, of which triphenyl phosphate is preferably used.

In a composition according to the present invention, a non-halogen-containing phosphate ester flame retardant is compounded within a range not smaller than 3 mass portions and not greater than 20 mass portions, preferably within a range not smaller than 5 mass portions and not greater than 15 mass portions, relative to 100 mass portions of thermoplastic resin. The nonflammability of the product is reduced when the compounding ratio is smaller than 3 mass portions, whereas the nonflammability does not improve relative to the ratio of the flame retardant and certain physical properties including impact-resistance of the resin composition can be degraded when the compounding ratio exceeds 20 mass portions. Thus, a non-halogen-containing phosphate ester flame retardant is compounded within a range not smaller than 3 mass portions and not greater than 20 mass portions relative to 100 mass portions of thermoplastic resin.

For example, a polyorganosiloxane that is same as an organopolysiloxane disclosed in Japanese Patent Laid-Open Publication No. Hei8-176425 is used for the purpose of the present invention. Organopolysiloxanes disclosed in the above cited patent document have a basic structure expressed by general formula (IX) shown below.
R1ₐ·R2_{b}·SiO_{(4-a-b)/2} (IX)

In the above general formula (IX), R1 represents a monovalent organic group containing an expoxy group. Specific examples of such monovalent organic groups include a γ-glycidoxypropyl group, a β-(3,4-epoxycyclohexyl)ethyl group, a glycidoxymethyl group and an epoxy group. From an industrial point of view, the use of a γ-glycidoxypropyl group is preferable. Further, R2 represents a hydrocarbon group having 1 to 12 carbon atoms. Examples of such hydrocarbon groups include alkyl groups having 1 to 12 carbon atoms, alkenyl groups having 2 to 12 carbon atoms, aryl groups having 6 to 12 carbon atoms and arylalkyl groups having 7 to 12 carbon atoms, although phenyl groups, vinyl groups and methyl groups are preferable. Specifically, when such a group is compounded in aromatic polycarbonate resin, the use of an organopolysiloxane containing phenyl groups that are highly compatible with the resin or organopolysiloxane that contains vinyl groups in order to raise the nonflammability is preferable.

Moreover, a and b are numbers that satisfy the relationships of 0<a<2, 0≦b<2 and 0<a+b<2. It is preferable that 0<a≦1. If any organic group (R1) containing epoxy groups is not contained at all (a=0), it is not possible to achieve a desired level of nonflammability because there is no reaction point with a phenolic hydroxyl group at a terminal of aromatic polycarbonate resin. If, on the other hand, a is not smaller than 2, it means that the obtained polysiloxane is expensive and hence disadvantageous in terms of economy. Thus, it is preferable that 0<a<2.

Meanwhile, if b is not smaller than 2, the organosiloxane is poorly heat-resistant and its nonflammability is reduced because it has a low molecular weight. Thus, it is preferable that 0≦b<2.

Organopolysiloxanes that meets the above requirements can be manufactured by hydrolyzing an epoxy-group-containing silane such as y-glycidoxypropyltrimethoxysilane, γ-glycidoxypropylmethyldiethoxysilane, β-(3,4-epoxycyclohexyl)ethyltrimethoxysilane or β-(3,4-epoxycyclohexyl)ethylmethyldiethoxysilane alone or cohydrolyzing such an epoxy-group-containing silane with other alkoxysilane monomer. Any known appropriate cohydrolyzing methods such as the one disclosed in Japanese Patent Laid-Open Publication No. Hei8-176425 may be used for the purpose of the present invention.

For the purpose of the invention, a polyorganosiloxane having an average molecular weight not smaller than 1,000 and not greater than 500,000 as reduced to polystyrene is preferably used. The product can show a reduced heat-resistance and a reduced strength when the average molecular weight is less than 1,000, whereas foaming can hardly take place when the average molecular weight exceeds 500,000. Thus, a polyorganosiloxane having an average molecular weight not smaller than 1,000 and not greater than 500,000 as reduced to polystyrene is preferably used.

In a composition containing the polyorganosiloxane and the thermoplastic resin according to the present invention, the selected polyorganosiloxane is used within a range between 0.05 mass portions and 5 mass portions relative to 100 mass portions of thermoplastic resin. When the compound ratio is smaller than 0.05 mass portions, the effect of preventing dropping during combustion is not sufficiently exerted and, as a result, the non flammability is reduced. When, on the other hand, the compound ratio is greater than 5 mass portions, the effect of preventing dropping during combustion does not improve relative to the ratio of the polyorganosiloxane and the impact-resistance and some other physical properties of the nonflammable resin composition are even degraded while the resin hardly foams. Thus, the polyorganosiloxane is used within a range between 0.05 mass portions and 5 mass portions relative to 100 mass portions of thermoplastic resin. Preferably, the compounding ratio of the polyorganosiloxane is not smaller than 0.10 mass portions and not greater than 2.0 mass portions relative to 100 mass portions of aromatic polycarbonate resin.

On the other hand, the metal salt type flame retardant to be used in the present invention is selected from organosulfonic acids of alkali metals and alkaline-earth metals disclosed in Japanese Patent Laid-Open Publication No. Hei7-25853, as well as known metal hydroxides including magnesium hydroxide, which may be 10A (tradename, available from Fukushima Kagaku Kogyo K. K.) or Kisuma 5 (tradename, available from Kyowa Chemical Co., Ltd, and aluminum hydroxide, which may be H-100 (tradename, available from Showa Denko K. K.).

Preferably, the selected metal hydroxide has an average particle diameter not smaller than 1 μm and not greater than 10 μm, and the content ratio of rough particles having a particle diameter not smaller than 15 μm is not higher than 10 mass %.

When the metal salt type flame retardant to be used in a composition according to the present invention is a metal hydroxide, it is compounded within a range not smaller than 50 mass portions and not greater than 300 mass portions relative to 100 mass portions of thermoplastic resin. The nonflammability is reduced when the compounding ratio is smaller than 50 mass portions, whereas the anti-impact strength and some other physical properties are degraded to offset the weight-lessening effect due to foaming and the composition hardly foams when the compounding ratio exceeds 300 mass portions. Thus, when the metal salt type flame retardant to be used in a composition according to the invention is a metal hydroxide, it is compounded preferably within a range not smaller than 50 mass portions and not greater than 300 mass portions, more preferably within a range not smaller than 75 mass portions and not greater than 200 mass portions, relative to 100 mass portions of thermoplastic resin.

When the metal salt type flame retardant is organosulfonic acid of an alkali metal or alkaline-earth metal, it is compounded within a range not smaller than 0.03 mass portions and not greater than 1 mass portion relative to 100 mass portions of thermoplastic resin. The nonflammability is reduced when the compounding ratio is smaller than 0.03 mass portions, whereas the nonflammability does not improve relative to the ratio of the flame retardant when the compounding ratio exceeds 1 mass portion. Thus, when the metal salt type flame retardant is organosulfonic acid of an alkali metal or alkaline-earth metal, it is compounded within a range not smaller than 0.03 mass portions and not greater than 1 mass portion relative to 100 mass portions of thermoplastic resin.

If necessary, a nonflammability assistant may be added for the purpose of the invention. For example, the use of polytetrafluoroethylene (PTFE) facilitates to obtain an excellent nonflammability and generate uniform and fine micro-cells. When polytetrafluoroethylene (PTFE) is used as nonflammability assistant for the purpose of the present invention, its average molecular weight needs to be not smaller than 500,000, preferably between 500,000 and 10,000,000. Of various polytetrafluoroethylenes (PTFEs), the use of one having fibril formability is preferable because such polytetrafluoroethylene (PTFE) can produce an even higher degree of nonflammability. Polytetrafluoroethylenes (PTFEs) having fibril formability include those classified as Type 3 in ASTM Standards. Specific examples of such chemicals include Teflon 6-J (tradename, available from Du Pont—Mitsui Fluorochemicals Co., Ltd.) and Polyflon D-1 and Polyflon F-103 (tradenames, available from Daikin Chemical Industries, Ltd.). Examples of polytetrafluoroethylenes (PTFEs) that do not fall in Type 3 include Algoflon F5 (tradename, available from [Montefluos Co., Ltd.?]) and Polyflon MPA FA-100 and F201 (tradenames, available from Daikin Chemical Industries, Ltd). Any of such polytetrafluoroethylenes (PTFEs) may be used alone or two or more than two different polytetrafluoroethylenes (PTFEs) may be used in combination.

For a composition according to the present invention, polytetrafluoroethylene (PTFE) is compounded within a range not smaller than 0.01 mass portions and not greater than 2 mass portions relative to 100 mass portions of thermoplastic resin. No effect is practically recognizable when the compounding ratio is smaller than 0.01 mass portions, whereas the effect of preventing dropping during combustion is not recognizably improved and the anti-impact strength and other physical properties are degraded while the obtained nonflammable resin composition hardly foams when the compounding ratio exceeds 2 mass portions. Thus, polytetrafluoroethylene (PTFE) is preferably compounded within a range not smaller than 0.01 mass portions and not greater than 2 mass portions relative to 100 mass portions of thermoplastic resin.

A nonflammable foam body according to the present invention is a foamed and molded body having a fine foam structure obtained by causing gas in a supercritical state to permeate into a nonflammable resin composition as described above and subsequently degassing the resin composition.

The foam structure may be a so-called independent foam body containing independent foam cells or a so-called continuous foam body containing no independent foam cells.

In the case of a continuous foam body, a resin phase and a pore phase are continuously formed in an intertwined manner to typically show a cyclic foam structure.

In the case of an independent foam body, the major axis of foam cells is preferably not greater than 10 μm, more preferably not greater than 5 μm. The advantage of a micro-cellular structure of maintaining the pre-foaming rigidity may not be sufficiently realized when the major axis of foam cells exceeds 10 μm. The obtained nonflammable foam body normally has a volume not smaller than 1.1 times and not greater than 3 times, preferably not smaller than 1.2 times and not greater than 2.5 times, of the volume of the original composition.

In the case of a continuous foam body having a cyclic foam structure, each cycle has a length not smaller than 5 nm and not greater than 100 μm, preferably not smaller than 10 nm and not greater than 50 μm. The foam structure becomes coarse and hurdle-like when the cycle exceeds 100 μm, whereas the pore phase becomes too small and the advantages of a continuous foam body such as a filtering effect may not be realized when the cycle is smaller than 5 nm. Consequently, one cycle of the continuous foam body has a length not smaller than 5 nm and not greater than 100 μm, preferably not smaller than 10 nm and not greater than 50 μm. Thus, while there are no limitations to the power by which the volume of a continuous foam body is magnified so long as a cyclic structure is maintained, it is normally not smaller than 1.1 and not greater than 3, preferably not smaller than 1.2 and not greater than 2.5.

Any method may be used to manufacture a foam body according to the present invention so long as it is adapted to cause gas in a supercritical state to permeate into a nonflammable resin composition as described above and subsequently degas the resin composition. Now, a method of manufacturing a foam body according to the present invention will be described below.

A supercritical state is a state between a gaseous state and a liquid state. A critical state appears when the temperature and the pressure of gas exceed certain respective points (critical points) that are specific to the type of gas. In a critical state, the effect of permeating into resin becomes intensified and uniform if compared with the effect in a liquid state.

For the purpose of the present invention, any gas that can permeate into resin in a supercritical state may be used. Examples of gas include carbon dioxide, nitrogen, air, oxygen, hydrogen and inert gas such as helium, of which carbon dioxide and nitrogen are preferable.

Both a method and an apparatus for manufacturing an independent foam body by causing gas in a supercritical state to permeate into a resin composition has a molding step of molding the resin composition and a foaming step of causing gas in a supercritical state to permeate into the molded body and subsequently causing the molded body to foam by degassing. A batch foaming method by which the molding step and the foaming step are conducted separately and a continuous foaming method by which the molding step and the foaming step are conducted continuously are known. For example, a molding method and a manufacturing apparatus as disclosed in U.S. Pat. No. 5,158,986 or in Japanese Patent Laid-Open Publication No. Hei10-230528 can be used.

When an injection or extrusion foaming method (continuous foaming method) of causing gas in a supercritical state to permeate into a nonflammable resin composition in an extruder is used in the present invention, gas in a supercritical state is blown into the resin composition that is being kneaded in the extruder. More specifically, when amorphous resin is used, the temperature in the gas atmosphere is made higher than a level close to the glass transition temperature Tg. To be more accurately, the temperature in the gas atmosphere is made higher than a level lower than the glass transition temperature Tg by 20° C. With this temperature arrangement, the amorphous resin and gas become uniformly compatible. The upper limit of the temperature range may be selected freely so long as it does not adversely affect the resin material, although it preferably does not exceed a level higher than the glass transition temperature Tg by 250° C. If the upper limit exceeds this temperature level, the foam cells or the cyclic structure of the nonflammable foam body can become too large and the resin composition can be degraded by heat to consequently reduce the strength of the nonflammable foam body. As far as the present invention is concerned, amorphous resin may be crystalline resin that is not oriented and practically amorphous.

When an injection/extrusion method of causing gas to permeate into crystalline resin in an extruder during an injection/extrusion molding process is used, the temperature in the gas atmosphere is made not higher than the melting point (Tm) plus 50° C. (Tm+50° C.). The resin composition may not be molten and kneaded sufficiently if the temperature in the gas atmosphere is lower than the melting point when gas is caused to permeate into the resin composition, whereas the resin can be decomposed if the temperature in the gas atmosphere is higher than (Tm+50)° C. Thus, the temperature in the gas atmosphere is preferably made not higher than the melting point (Tm) plus 50° C. (Tm+50° C.).

When a batch foaming method of causing gas to permeate into the crystalline resin that is filled in an autoclave, the temperature in the gas atmosphere is made not lower than the crystallizing temperature (Tc) less 20° C. (Tc−20° C.) and not higher than the crystallizing temperature (Tc) plus 50° C. (Tc+50° C.). Even gas in a supercritical state can hardly permeate and only provides a poor foaming effect if the temperature in the gas atmosphere is lower than (Tc−20)° C., whereas a coarse foam structure is produced if the temperature in the gas atmosphere exceeds (Tc+50)° C. Thus, the temperature in the gas atmosphere is preferably made not lower than the (Tc−20)° C. and not higher than the crystallizing temperature (Tc+50)° C.

The gas pressure under which gas is caused to permeate into resin is required to be not lower than the critical pressure of the gas, preferably not lower than 15 MPa, more preferably not lower than 20 MPa.

The rate at which gas is caused to permeate into resin is determined on the basis of the power of magnification to be used for foaming the resin. For the purpose of the present invention, it is normally not lower than 0.1 mass % and not higher than 20 mass %, preferably not lower than 1 mass % and not higher than 10 mass % relative to the mass of the resin.

There are no particular limitations to the duration of time during which gas is caused to permeate into the resin and the duration may be appropriately selected depending on the method to be used for permeation and the thickness of the resin. The amount of gas that is caused to permeate and the cyclic structure are correlated in such a way that the cyclic structure will become large when gas is caused to permeate to a large extent, whereas the cyclic structure will become small when gas is caused to permeate to a lesser extent.

When a batch system is used for causing gas to permeate into the resin, the duration is normally not shorter than 10 minutes and not longer than 2 days, preferably not shorter than 30 minutes and not longer than 3 hours. When an injection/extrusion method is used, the duration is not shorter than 20 seconds and not longer than 10 minutes because the efficiency of permeation is high.

A nonflammable foam body according to the present invention is obtained by causing gas in a supercritical state to permeate into a nonflammable resin composition and subsequently degassing by reducing the pressure. In view of the foaming operation, it is sufficient to lower the pressure of the gas caused to permeate into the resin composition to a level below the critical pressure. However, it is normally lowered to the level of atmospheric pressure from the viewpoint of easy handling and the gas is cooled while the pressure thereof is being lowered.

Preferably, the nonflammable resin composition into which gas in a supercritical state has been caused to permeate is cooled to (Tc±20)° C. at the time of degassing. When the resin composition is degassed at temperature outside the above temperature range, coarse foam can be generated and the degree of crystallization can be insufficient to reduce the strength and the rigidity of the produced foam body if the resin composition foams uniformly.

When an injection or extrusion foaming method (continuous foaming method) as described above is used, it is particularly preferable to reduce the pressure applied to the resin composition, into which gas in a supercritical state has been caused to permeate, by retracting the metal mold after filling the metal mold with the resin composition that has been permeated with gas in a supercritical state. As a result of such an operation, no defective foaming occurs at and near the gate of the metal mold and a homogeneous foam structure is obtained.

When a batch foaming method of placing a molded nonflammable resin composition into an autoclave filled with gas in a supercritical state and causing gas to permeate into the resin composition is used, the degassing conditions may be substantially same as those described above for the injection or extrusion foaming method (continuous foaming method). The temperature range of (Tc±20)° C. may be observed for a time period sufficient for degassing.

Regardless if a continuous foaming method or a batch foaming method is used, preferably the resin composition is cooled to a temperature level below the crystallization temperature at a rate lower than 0.5° C./sec in order to obtain a foam structure having uniform and independent foam cells. If the cooling rate exceeds 0.5° C./sec, continuous foam sections can be generated in addition to independent foam cells to baffle the effort of producing a uniform foam structure. Thus, the resin composition is cooled at a rate lower than 0.5° C./sec.

To obtain a foam structure having uniform and independent foam cells, the pressure reducing rate of the resin composition is preferably lower than 20 MPa/sec, more preferably lower than 15 MPa/sec, most preferably lower than 0.5 MPa/sec. Continuous foam sections can be generated apart from independent foam cells to make it impossible to obtain a uniform foam structure when the pressure reducing rate is not lower than 20 MPa/sec. Thus, it is preferable for the purpose of the present invention to maintain the pressure reducing rate of the resin composition to a level lower than 20 MPa/sec. As a result of research, it was found that spherical independent bubbles can be easily formed if the resin composition is not cooled or cooled at a very low rate even when the pressure reducing rate is not lower than 20 MPa/sec.

When, on the other hand, manufacturing a nonflammable foam body in which a resin phase and a pore phase are continuously formed in an intertwined manner to typically show a cyclic foam structure, gas in a supercritical state is caused to permeate into the resin composition containing crystalline resin and laminar silicate and the resin composition permeated with gas is subjected to rapid cooling and rapid pressure reduction simultaneously. As a result of this operation, a pore phase is produced after degassing and the pore phase and the resin phase are continuous and held to an intertwined state.

A method and an apparatus similar to those used for manufacturing an independent foam cell type foam body can also be used for causing gas in a supercritical state to permeate into resin. The temperature and the pressure at which gas in a supercritical state is caused to permeate into the resin composition may also be same as those used for manufacturing the independent foam cell type foam body. After the gas permeation, the resin composition is cooled at a cooling rate not lower than 0.5° C./sec, preferably not lower than 5° C./sec, more preferably not lower than 10° C./sec. While the upper limit of the cooling rate may vary depending on the method of manufacturing a nonflammable foam body, it is 50° C./sec for the batch foaming method and 1,000° C./sec for the continuous foaming method. The pore phase takes a form of independent spherical bubbles and hence it is not possible to obtain the functional feature of a continuous pore structure if the cooling rate is lower than 0.5° C., whereas a large cooling facility is required to raise the cost of manufacturing a nonflammable foam body if the cooling rate exceeds the upper limit value. Thus, the resin composition is preferably cooled at a cooling rate not lower than 0.5° C./sec and not higher than 50° C./sec for the batch foaming method and not lower than 0.5° C./sec and not higher than 1,000° C./sec for the continuous foaming method.

The pressure reducing rate in the degassing step is preferably not lower than 0.5 MPa/sec, more preferably not lower than 15 MPa/sec, most preferably not lower than 20 MPa/sec and not higher than 50 MPa/sec. The obtained continuous porous structure is frozen and maintained when the pressure is reduced to ultimately equal to 50 MPa or less. The pore phase takes a form of independent spherical bubbles and hence it is not possible to obtain the functional feature of a continuous pore structure if the cooling rate is lower than 0.5 MPa/sec, whereas a large cooling facility is required to raise the cost of manufacturing a nonflammable foam body if the cooling rate exceeds 50 MPa/sec. Thus, the resin composition is preferably cooled at a cooling rate not lower than 0.5 MPa/sec and not higher than 50 MPa/sec.

Then, pressure reduction and cooling are conducted substantially simultaneously. The expression of substantially simultaneously as used herein means that errors are allowed so long as the objective of the present invention is achieved. As a result of research, it has been found that no problems arise when the resin permeated with gas is rapidly cooled first and then subjected to rapid pressure reduction, although independent spherical bubbles are apt to be formed in the resin when the resin is subjected to rapid pressure reduction without being cooled.

### BRIEF DESCRIPTION OF THE DRAWINGS

FIGS. 1A and 1B schematically illustrate a resin foam body which is a foam body according to an embodiment of the present invention. FIG. 1A is an enlarged schematic perspective view of a principal pair of the resin foam body and FIG. 1B is a two-dimensional schematic illustration of the resin foam body.

FIGS. 2A and 2B illustrate an apparatus for realizing a method (batch foaming method) of manufacturing a resin foam body according to an embodiment of the present invention. FIG. 2A is a schematic illustration of the apparatus for conducting the permeation step of gas in a supercritical state and FIG. 2B is a schematic illustration of the apparatus for conducting the cooling/pressure reducing step.

FIG. 3 schematically illustrates an apparatus for realizing a method (continuous foaming method) of manufacturing a resin foam body according to an embodiment of the present invention.

### BEST MODE FOR CARRYING OUT THE INVENTION

Now, an embodiment of the present invention will be described by referring to the accompanying drawings.

For the purpose of the present invention, a nonflammable resin composition that is made to foam can be manufactured by sufficiently kneading the ingredients of the composition, which will be described hereinafter for Examples, by a known method, such as the use of a blender and subsequently melting and kneading it by a biaxial kneading machine.

The resin composition foams in order to obtain a nonflammable foam body characterized by containing foam cells whose major axis is not longer than 10 μm and showing a cyclic structure with a cycle of not shorter than 5 nm and not longer than 100 μm. Hereinafter, a molding method or the like of the nonflammable foal body will be described. Of nonflammable foam bodies according to the present invention, those of the independent foam type show a structure similar to known foam bodies having independent foam cells. Howevre, the major axis of foam cells of a nonflammable foam body according to the invention is very small and not longer than 0.10 μm.

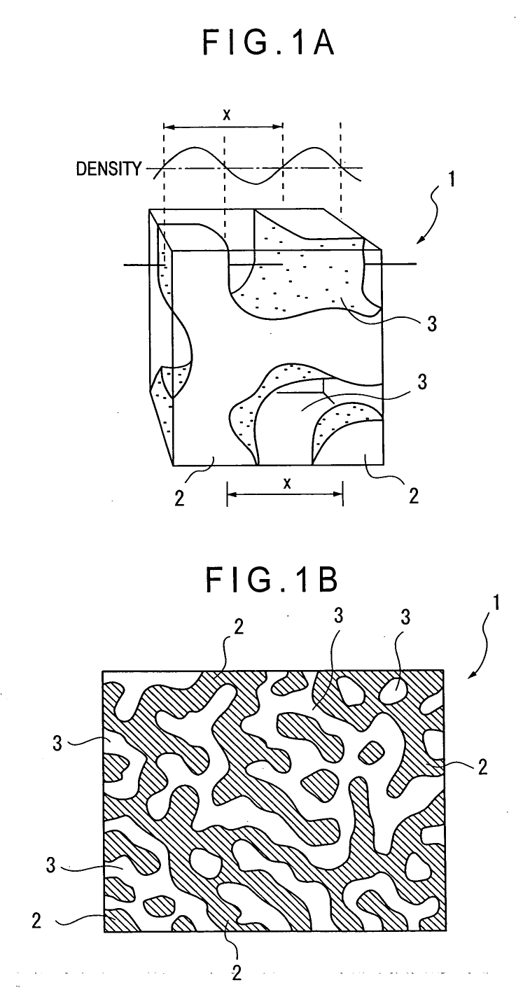

Referring to FIGS. 1A and 1B, reference symbol 1 denotes a resin foam body that is a nonflammable foam body. A resin phase 2 that is referred to as matrix phase and a pore phase 3 are continuously formed in the resin foam body 1 and intertwined to show a cyclic structure. The cyclic structure is referred to as modulated structure, in which the density of the resin phase 2 and that of the pore phase 3 fluctuate cyclically. A cycle of fluctuations has a length X that is equal to that of a cycle of the cyclic structure. In this embodiment, the length X of a cycle is not smaller than 5 nm and not greater than 100 μm, preferably not smaller than 10 nm and not greater than 50 μm.

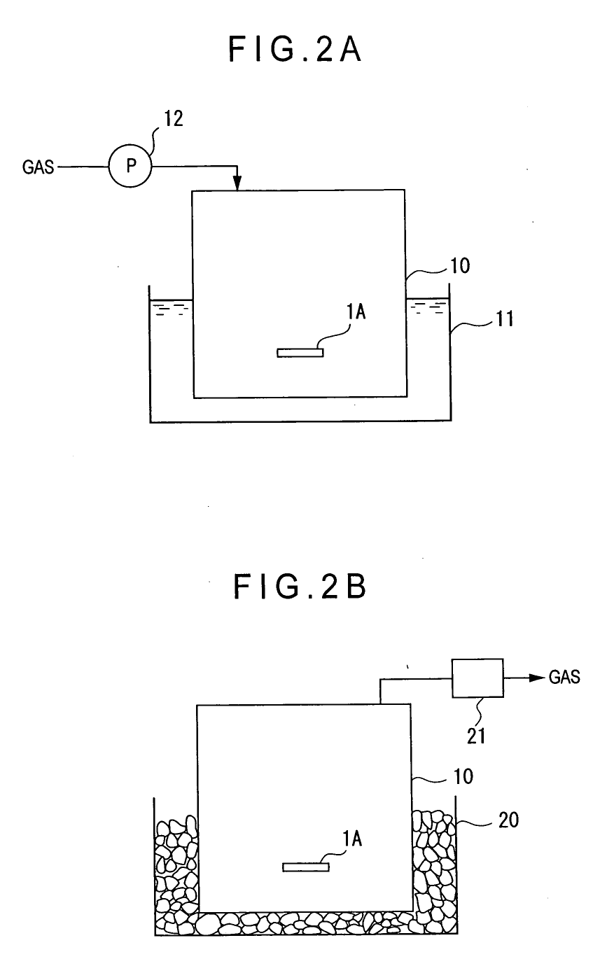

Now, the method of manufacturing the resin foam body 1 according to the embodiment of the present invention will be described by referring to FIGS. 2A and 2B.

FIG. 2A illustrates an apparatus to be used for the permeation step of a batch foaming method and FIG. 2B illustrates an apparatus to be used for the cooling/pressure reducing step.

Referring to FIG. 2A, a predetermined resin composition 1A is arranged in the inside of an autoclave 10. The autoclave 10 is dipped in an oil bath 11 for heating the resin composition 1A and gas to be caused to permeate into the resin composition 1A is supplied to the inside of the autoclave 10 by a pump 12.

In this embodiment, the temperature of the resin composition 1A is raised to a temperature range not lower than (crystallization temperature [Tc] of the resin composition 1A−20)° C. and not higher than (Tc+50)° C. As a result, the resin composition 1A is put in a gas atmosphere, where the gas is held in a supercritical state.

Referring to FIG. 2B, the autoclave 10 is then put into an ice bath 20. The ice bath 20 is such that a coolant such as dry ice and warm water or oil to be used for gradual cooling can be introduced into and discharged from it. The resin composition 1A is cooled as the autoclave 10 is cooled.

A pressure regulator 21 is connected to the autoclave 10 so that the internal pressure of the autoclave 10 is regulated by regulating the amount of gas discharged from the autoclave 10. Note that the ice bath 20 may be replaced by an ice box or a water bath for this embodiment.

When a nonflammable foam body having independent foam cells is to be obtained by this embodiment, the resin composition 1A that has been permeated with gas can be degassed either by cooling or by reducing the pressure of the resin composition 1A. When on the other hand, a nonflammable foam body having a cyclic structure as shown in FIGS. 1A and 1B is to be obtained, the resin composition 1A that has been permeated with gas is degassed by rapidly cooling and rapidly reducing the pressure of the resin composition 1A substantially simultaneously. The cooling rate and the pressure reducing rate to be used for the resin composition 1A are found within the above-described respective ranges.

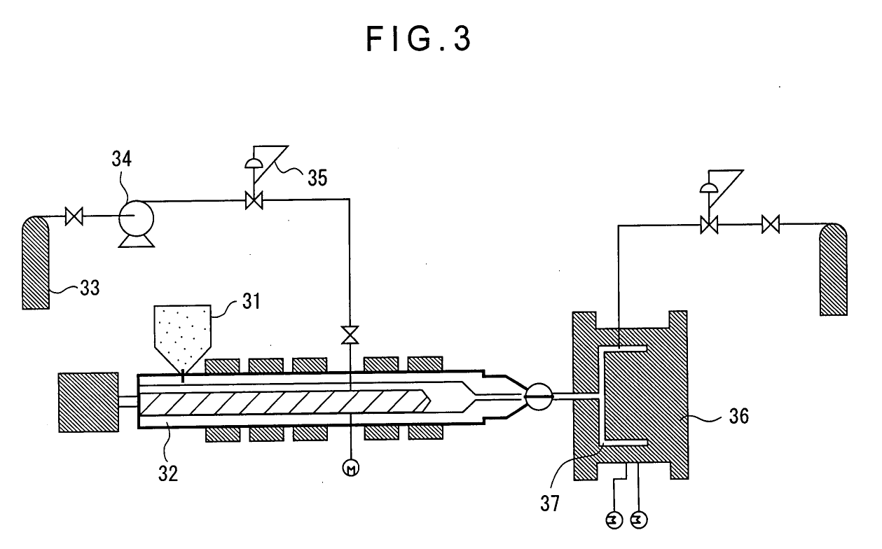

FIG. 3 schematically illustrates an apparatus for realizing a continuous foaming method according to which the permeation step of gas in a supercritical state is conducted during the injection molding operation.

A nonflammable resin composition as described above is put into an injection molding machine by a hopper. Then, the pressure and the temperature of carbon dioxide or nitrogen supplied from a gas cylinder are raised respectively above the critical pressure and the critical temperature thereof by a pressure booster. Then, the control pump is opened and gas blows into the injection molding machine to cause gas in a supercritical state to permeate into the nonflammable resin composition.

The nonflammable resin composition that has been permeated with gas in a supercritical state is then filled in the cavity of a metal mold. If the pressure being applied to the resin composition is reduced as the resin composition flows into the cavity of the metal mold, the gas with which the resin composition has been permeated can escape, if partly, before the cavity of the metal mold is completely filled with the resin composition. Counter pressure may be applied to the inside of the cavity of the metal mold in order to avoid such a situation. When the cavity of the metal mold is completely filled with the resin composition, the mold pressure being applied to the inside of the cavity is reduced. As a result, the pressure being applied to the resin composition is rapidly reduced to accelerate degassing.

If necessary, a nonflammable foam body according to the present invention may contain an inorganic filler such as alumina, silicon nitride, talc, mica, titanium oxide, clay compound or carbon black, an antioxidant, a photo stabilizer and/or a pigment by not less than 0.01 mass % and not more than 30 mass %, preferably not less than 0.1 mass % and not more than 10 mass %, relative to 100 mass % of the foam body. When strength and rigidity are required, it may contain carbon fiber or glass fiber by not less than 1 mass % and not more than 100 mass %, relative to 100 mass % of the nonflammable foam body.

Now, advantages of the present invention will be described further by way of specific examples. However, the present invention is by no means limited to the examples.

[Regulation of Raw Materials (Compounding Examples 1 through 23)]

The raw materials are dry blended to show compounding ratios shown in Tables 1 and 2. The ingredients listed in Table 3 are used for the compositions of Tables 1 and 2.

TABLE 1

| non-flammable | | | | | | | | | | |
|---|---|---|---|---|---|---|---|---|---|---|
| MC | | | | | | | | | | |
| structure | Resin matrix | | | | | | | | | |
| body | | branched | | | | | branched | | | |
| material | PC | PC | PC-PDMS | SPS | PS | PMMA | PP | ABS | PET | PBT |
| cmp ex. 1 | 100 | | | | | | | | | |
| cmp ex. 2 | | 100 | | | | | | | | |
| cmp ex. 3 | | 90 | | | | | | | | |
| cmp ex. 4 | 100 | | | | | | | | | |
| cmp ex. 5 | | 100 | | | | | | | | |
| cmp ex. 6 | | 100 | | | | | | | | |
| cmp ex. 7 | | 90 | | | | | | | | |
| cmp ex. 8 | | 90 | | | | | | | | |
| cmp ex. 9 | | 80 | | | | | | | | |
| cmp ex. 10 | | 80 | | | | | | | | |
| cmp ex. 11 | | 60 | | | | | | | | |
| cmp ex. 12 | | | 100 | | | | | | | |
| cmp ex. 13 | | | 100 | | | | | | | |
| cmp ex. 14 | | 50 | 50 | | | | | | | |
| cmp ex. 15 | | 75 | | 15 | | | | | | |
| cmp ex. 16 | | 80 | | | 10 | | | | | |
| cmp ex. 17 | | 80 | | | | 10 | | | | |
| cmp ex. 18 | | 80 | | | | | | 10 | | |
| cmp ex. 19 | | 70 | | | | | | | 20 | |
| cmp ex. 20 | | 70 | | | | | | | | 20 |
| cmp ex. 21 | | | | 90 | | | | | | |
| cmp ex. 22 | | | | | | 90 | | | | |
| cmp ex. 23 | | | | | | | 40 | | | |

TABLE 2

| nonflammable | | | | | | | | | | | |
|---|---|---|---|---|---|---|---|---|---|---|---|
| MC | flame retardant and nonflammability promoter | | | | | | | | | | |
| structure | | | salt-based | | | | | | inorganic filler | | anti-oxidant |
| body | TBA | decabrom | flame | | | organo- | organo- | magnesium | or fiber | | magnesium |
| material | oligomer | diphenilthane | retardant | PFR | PTFE | polysiloxane 1 | polysiloxane 2 | hydroxide | talc | GF | hydroxide 1 |
| cmp ex. 1 | | | | | | | | | | | 0.1 |
| cmp ex. 2 | | | | | | | | | | | 0.1 |
| cmp ex. 3 | 10 | | | | | | | | | | 0.1 |
| cmp ex. 4 | | | 0.5 | | 0.3 | | | | | | 0.1 |
| cmp ex. 5 | | | 0.5 | | | | 0.3 | | | | 0.1 |
| cmp ex. 6 | | | 0.5 | | 0.3 | 0.3 | | | | | 0.1 |
| cmp ex. 7 | | | | 10 | 0.3 | | | | | | 0.1 |
| cmp ex. 8 | | | | 10 | 0.3 | | | | | | 0.1 |
| cmp ex. 9 | | | | 10 | 0.3 | | | | 10 | | 0.1 |
| cmp ex. 10 | | | | 10 | 0.3 | | | | | 10 | 0.1 |
| cmp ex. 11 | | | | 10 | 0.3 | | | | | 30 | 0.1 |
| cmp ex. 12 | | | | | | | | | | | 0.1 |
| cmp ex. 13 | | | | | 0.3 | | | | | | 0.1 |
| cmp ex. 14 | | | | | 0.3 | | | | | | 0.1 |
| cmp ex. 15 | | | | 10 | 0.3 | | | | | | 0.1 |
| cmp ex. 16 | | | | 10 | 0.3 | | | | | | 0.1 |
| cmp ex. 17 | | | | 10 | 0.3 | | | | | | 0.1 |
| cmp ex. 18 | | | | 10 | 0.3 | | | | | | 0.1 |
| cmp ex. 19 | | | | 10 | 0.3 | | | | | | 0.1 |
| cmp ex. 20 | | | | 10 | 0.3 | | | | | | 0.1 |
| cmp ex. 21 | | 10 | | | 0.5 | | | | | | 0.1 |
| cmp ex. 22 | | 10 | | | 0.5 | | | | | | 0.1 |
| cmp ex. 23 | | | | | | | | 60 | | | 0.1 |

TABLE 3

| Raw material | Manufacturer | Trade name |
|---|---|---|
| PC | Idemitsu Petrochemical Co., Ltd. | Tarflon FN1700A |
| Branched PC | Idemitsu Petrochemical Co., Ltd. | Tarflon FB2500A |
| PC-PDMS | Idemitsu Petrochemical Co., Ltd. | Tarflon FC1700A |
| SPS | Idemitsu Petrochemical Co., Ltd. | Xarec 130ZC |
| HIPS | Idemitsu Petrochemical Co., Ltd. | IT44 |
| PMMA | Sumitomo Chemical Co., Ltd. | Sumipex MHF |
| Branched PP | SunAllomer K. K. | PF814 |
| ABS | Ube Cycon, Ltd. | AT-05 |
| PET | Mitsubishi Rayon Co., Ltd. | MA-523-V-D |
| PBT | Mitsubishi Rayon Co., Ltd. | N1300 |
| TBA oligomer | Teijin Ltd. | FG7500 |
| decabromediphenylthane | Albert Asano Co., Ltd. ? | SYTEX801 |
| salt-based flame retardant | Dainippon Ink & Chemicals, Inc. | F114 |
| phosphorus-based flame retardant | Asahi Denka Kogyo K. K. | ADKSTAB PFR |
| PTFE | Daikin Chemical Industries, Ltd. | F201L |
| organopolysiloxane 1 | Dow Corning Toray Silicone Co., Ltd. | SR2401 |
| organopolysiloxane 2 | Shin-Etsu Silicone Co., Ltd. | KR219 |
| magnesium hydroxide | Konoshima Chemical Co., Ltd. | 10A |
| Talc | Asada Milling Co., Ltd. | FFR |
| GR (glass fiber) | Asahi Fiber Glass Co., Ltd. | MA409C |
| antioxidant | Asahi Denka Kogyo K. K. | ADKSTAB PEP36 |

[Preparation of Film Prior to Foaming (Manufacturing Examples 1 through 23)]
(1) Manufacturing Example 1

The specimen of Compounding Example 1 as listed on Table 1 was kneaded in a 35 mm biaxial kneading/extruding machine at kneading temperature of 28° C. and screw revolving rate of 300 rpm to obtain pellets. The obtained pellets were pressed in a press molding machine at press temperature 280° C. gauge pressure of 100 kg/cm² to obtain a 150 nm square×300 μm film.

(2) Manufacturing Examples 2 through 23

Films were formed by a 35 mm biaxial kneading/extruding machine and a press molding machine as in the Manufacturing Example 1 except that the kneading temperature of the kneading operation and the gauge pressure and the press temperature of the press operation were differentiated as shown in Table 4 below for some of the specimens.

TABLE 4

| | preparation of press film prior to foaming | | | |
|---|---|---|---|---|
| | | kneading | gauge | press |
| | | temp. | pressure | temperature |
| step | compounding | [° C.] | [kg/cm²] | [° C.] |
| Manufac. Ex. 1 | Comp. Ex. 1 | 280 | 100 | 280 |
| Manufac. Ex. 2 | Comp. Ex. 2 | 280 | 100 | 280 |
| Manufac. Ex. 3 | Comp. Ex. 3 | 280 | 100 | 280 |
| Manufac. Ex. 4 | Comp. Ex. 4 | 280 | 100 | 280 |
| Manufac. Ex. 5 | Comp. Ex. 5 | 280 | 100 | 280 |
| Manufac. Ex. 6 | Comp. Ex. 6 | 280 | 100 | 280 |
| Manufac. Ex. 7 | Comp. Ex. 7 | 280 | 100 | 280 |
| Manufac. Ex. 8 | Comp. Ex. 8 | 280 | 100 | 280 |
| Manufac. Ex. 9 | Comp. Ex. 9 | 280 | 100 | 280 |
| Manufac. Ex. 10 | Comp. Ex. 10 | 280 | 100 | 280 |
| Manufac. Ex. 11 | Comp. Ex. 11 | 280 | 100 | 280 |
| Manufac. Ex. 12 | Comp. Ex. 12 | 280 | 100 | 280 |
| Manufac. Ex. 13 | Comp. Ex. 13 | 280 | 100 | 280 |
| Manufac. Ex. 14 | Comp. Ex. 14 | 280 | 100 | 280 |
| Manufac. Ex. 15 | Comp. Ex. 15 | 260 | 100 | 260 |
| Manufac. Ex. 16 | Comp. Ex. 16 | 260 | 100 | 260 |
| Manufac. Ex. 17 | Comp. Ex. 17 | 260 | 100 | 260 |
| Manufac. Ex. 18 | Comp. Ex. 18 | 260 | 100 | 260 |
| Manufac. Ex. 19 | Comp. Ex. 19 | 280 | 100 | 280 |
| Manufac. Ex. 20 | Comp. Ex. 20 | 260 | 100 | 260 |
| Manufac. Ex. 21 | Comp. Ex. 21 | 290 | 100 | 290 |
| Manufac. Ex. 22 | Comp. Ex. 22 | 230 | 100 | 230 |
| Manufac. Ex. 23 | Comp. Ex. 23 | 230 | 100 | 230 |

### EXAMPLE 1

The specimen of film, which was a resin composition, obtained in Manufacturing Example 3 in Table 4 was placed in the autoclave 10 (inside dimensions 40 mmø100×150 nm) of a supercritical foaming apparatus as shown in FIG. 2A. Then, the internal pressure was raised at room temperature and carbon dioxide in a supercritical state was introduced into the autoclave 10 as gas in a supercritical state. The internal pressure was raised to 15 MPa at room temperature and then the autoclave 10 was dipped into an oil bath 11 at oil temperature of 140° C. for an hour.

Subsequently, the pressure valve was opened and the internal pressure was made to fall to the atmospheric pressure in about 7 seconds. Simultaneously, the autoclave 10 was dipped into a water bath at bathing temperature of 25° C. to produce a foam film, which was a nonflammable foam body.

The obtained foam film was assessed in a manner as described below. The results of the assessment are listed in Table 5.

(1) Average Particle Diameter of Foam Cells, Density and Uniformity of Cells

The foam film was assessed for these matters by an ordinary visual method using a SEM photograph of the foam film. The uniformity of cells were assessed by observing the SEM photograph.

(2) Nonflammability

The flame of a disposable lighter (S-EIGHT: tradename, available from Hirota Co., Ltd) was adjusted to about 2 cm and a test piece of 5 mm×10 mm obtained by cutting the foam film was exposed to the flame at an end facet thereof for 1 second. The duration from the time when the test piece caught fire and the time when the fire was gone was observed.

### EXAMPLES 2 THROUGH 21, COMPARATIVE EXAMPLES 1 THROUGH 23

The specimens of these examples were obtained by foaming as in Example 1 except carbon dioxide in a supercritical state was caused to permeate into the respective films obtained in Manufacturing Examples as listed in Tables 5 and 6. The results are shown in Table 5 (Examples) and Table 6 (Comparative Examples). Note that the specimens of Comparative Examples 2 through 23 were not foamed.

TABLE 5

| | | | | | | | | | nonflammability |
|---|---|---|---|---|---|---|---|---|---|
| | | material to | foaming condition | | | foam structure | | | combustion time |
| | | be assessed | (permeation of CO₂ for 1 hr.) | | | cell density | average | | from ignition to |
| | | manufacturing | pressure | oil bath | water bath | (number/ | diameter | cell | extinguish |
| category | example | example | (MPa) | temp. (° C.) | temp. (° C.) | cm³) | (μm) | uniformity | (sec) |
| example | 1 | 3 | 15 | 140 | 25 | 2 × 10⁹ | 8 | ◯ | <1 |
| | 2 | 6 | 15 | 140 | 25 | 1 × 10¹⁰ | 10 | ◯ | <1 |
| | 3 | 7 | 15 | 140 | 25 | 4 × 10⁹ | 7 | ◯ | <1 |
| | 4 | 8 | 15 | 140 | 25 | 5 × 10⁹ | 6 | ◯ | <1 |
| | 5 | 9 | 15 | 140 | 25 | 3 × 10⁹ | 7 | ◯ | no fire |
| | 6 | 10 | 15 | 140 | 25 | 6 × 10⁹ | 6 | ◯ | no fire |
| | 7 | 11 | 15 | 140 | 25 | 2 × 10¹⁰ | 8 | ◯ | no fire |
| | 8 | 12 | 15 | 140 | 25 | 1 × 10¹⁰ | 9 | ◯ | no fire |
| | 9 | 13 | 15 | 140 | 25 | 3 × 10¹⁰ | 3 | ◯ | no fire |
| | 10 | 14 | 15 | 140 | 25 | 2 × 10¹⁰ | 8 | ◯ | <1 |
| | 11 | 15 | 15 | 140 | 25 | 6 × 10¹⁰ | 5 | ◯ | <1 |
| | 12 | 16 | 15 | 140 | 25 | 9 × 10⁹ | 10 | ◯ | <1 |
| | 13 | 17 | 15 | 140 | 25 | 5 × 10⁸ | 15 | ◯ | no fire |
| | 14 | 18 | 15 | 140 | 25 | 2 × 10¹⁰ | 9 | ◯ | no fire |
| | 15 | 19 | 15 | 140 | 25 | 9 × 10⁹ | 10 | ◯ | no fire |
| | 16 | 20 | 15 | 140 | 25 | 8 × 10⁹ | 11 | ◯ | no fire |
| | 17 | 21 | 15 | 140 | 25 | 1 × 10¹⁰ | 9 | ◯ | no fire |
| | 18 | 22 | 15 | 140 | 25 | 3 × 10¹⁰ | 8 | ◯ | no fire |
| | 19 | 23 | 15 | 140 | 25 | 2 × 10⁹ | 8 | ◯ | no fire |

TABLE 6

| | | | foaming condition | | | | | | nonflammability |
|---|---|---|---|---|---|---|---|---|---|
| | | material to be | (permeation of | | | | | | combustion time |
| | | assessed | CO₂ for 1 hr.) | | | foaming structure | | | from ignition to |
| | comparitive | manufacturing | pressure | oil bath | water bath | cell density | average dia. | cell | extinguish |
| category | example | example | (MPa) | (° C.) | (° C.) | (num./cm³) | (μm) | uniformity | (sec) |
| comparative | 1 | 1 | 15 | 140 | 25 | 2 × 10⁸ | 10 | ◯ | 6 |
| example | 2 | 2 | 15 | 140 | 25 | 2 × 10⁹ | 8 | ◯ | 5 |

| | | | | |
|---|---|---|---|---|
| 3 | 3 | (no forming) | (no forming) | 3 |
| 4 | 4 | (no forming) | (no forming) | 3 |
| 5 | 5 | (no forming) | (no forming) | no fire |
| 6 | 6 | (no forming) | (no forming) | no fire |
| 7 | 7 | (no forming) | (no forming) | no fire |
| 8 | 8 | (no forming) | (no forming) | no fire |
| 9 | 9 | (no forming) | (no forming) | no fire |
| 10 | 10 | (no forming) | (no forming) | no fire |
| 11 | 11 | (no forming) | (no forming) | no fire |
| 12 | 12 | (no forming) | (no forming) | no fire |
| 13 | 13 | (no forming) | (no forming) | no fire |
| 14 | 14 | (no forming) | (no forming) | no fire |
| 15 | 15 | (no forming) | (no forming) | no fire |
| 16 | 16 | (no forming) | (no forming) | no fire |
| 17 | 17 | (no forming) | (no forming) | no fire |
| 18 | 18 | (no forming) | (no forming) | no fire |
| 19 | 19 | (no forming) | (no forming) | no fire |
| 20 | 20 | (no forming) | (no forming) | no fire |
| 21 | 21 | (no forming) | (no forming) | no fire |
| 22 | 22 | (no forming) | (no forming) | no fire |
| 23 | 23 | (no forming) | (no forming) | no fire |

### INDUSTRIAL APPLICABILITY

The present invention relates to a nonflammable foam body produced by causing a nonflammable resin composition to foam finely and a method of manufacturing such foam body. The present invention is applicable to OA apparatus, electric and electronic apparatus and parts, automobile parts and the like required to have physical properties including strength, rigidity and impact-resistance, and further required to be lightweight and nonflammable.

What is claimed is:

1. A method of manufacturing a nonflammable foam body, comprising the steps of:
providing a resin composition containing thermoplastic resin and a flame retardant in an autoclave;
feeding a gas into the autoclave;
while controlling a pressure inside the autoclave, the temperature of the resin composition is raised to a range from (Tg−20)° C. to (Tg+50)° C., wherein Tg is the glass transition temperature of the resin composition, to permeate a supercritical gas into the resin composition; and
degassing the resin composition by depressurizing or cooling the inside of the autoclave.

2. The method according to claim 1, wherein the thermoplastic resin is polycarbonate.

3. The method according to claim 2, wherein the polycarbonate is at least one of polycarbonate having branches and polycarbonate-polyorganosiloxane copolymer containing a polydiorganosiloxane part.

4. The method according to claim 2, wherein the flame retardant is at least one selected from the group consisting of phosphorus-based flame retardants, metal-salt-based flame retardants and polyorganosiloxane-based flame retardants.

5. The method according to claim 2, wherein the resin composition contains polytetrafluoroethylene as nonflammability assistant.

6. The method according to claim 3, wherein the flame retardant is at least one selected from the group consisting of phosphorus-based flame retardants, metal-salt-based flame retardants and polyorganosiloxane-based flame retardants.

7. The method according to claim 3, wherein the resin composition contains polytetrafluoroethylene as nonflammability assistant.

8. The method according to claim 4, wherein the resin composition contains polytetrafluoroethylene as nonflammability assistant.

9. The method according to claim 6, wherein the resin composition contains polytetrafluoroethylene as nonflammability assistant.

10. A method for manufacturing a nonflammable foam body, comprising:
loading a resin composition into an injection molding machine having a die cavity;
blowing a gas into the injection molding machine;
raising the temperature of the gas above a critical temperature thereof and raising a pressure applied to the gas above a critical pressure;
filling the die cavity with the resin composition; and
reducing the pressure inside the die cavity to degas the resin composition.

11. A nonflammable foam body manufactured by the method according to claim 1.

12. A nonflammable foam body manufactured by the method according to claim 10.
